(19) United States
(12) Patent Application Publication
(10) Pub. No.: US 2026/0034629 A1
(43) Pub. Date: Feb. 5, 2026

(54) Layout Tape With Cutting Lubricant

(71) Applicant: Wolfram Labs, LLC, Groveport, OH (US)

(72) Inventors: Joel Vaughn, Groveport, OH (US); Ken Vaughn, Groveport, OH (US)

(21) Appl. No.: 19/286,543

(22) Filed: Jul. 31, 2025

Related U.S. Application Data
(60) Provisional application No. 63/678,230, filed on Aug. 1, 2024.

(51) Int. Cl. B23Q 11/10; C09J 7/29

(52) U.S. Cl. CPC B23Q 11/10; C09J 7/29

(57) ABSTRACT

An adhesive article for presenting cutting lubricant to a workpiece. The adhesive composition provides a means of attachment of lubricant to the workpiece and removal from the workpiece once the task of cutting, drilling, punching, shearing and/or sawing has been completed.

### BACKGROUND OF THE INVENTION

The present invention relates generally to the field of cutting lubricants for shearing, sawing, punching, drilling, or any other modification of a workpiece by removal or deformation of materials such as metal, plastics, composites, wood, etc. The invention also relates to tape for protecting, laying out, and marking surfaces.

It is common practice to utilize a cutting fluid when shearing, sawing, punching and, drilling materials. Such cutting fluids provide advantages, such as reduced burs, longer tool life, faster cutting, reduced loads, etc. It is also common to mark the material to be cut, punched or drilled directly or using tape, which may then be marked up. It is common practice to utilize tape such as a painter's tape to mark on materials such as metal, plastics, composites, wood, etc. This is done to produce both a high contrast mark and/or to protect the surface during marking and follow up operations such as sawing or drilling that might damage the surface.

It is also known to use tape and then apply a cutting fluid. This can be cumbersome and time consuming. Furthermore, the cutting fluid can obscure or remove marks, spread over a great distance, ruin a finished surface, require extensive cleanup, etc.

Therefore, there is a need for a marking device that works better with cutting fluid than the conventional products.

### SUMMARY OF THE INVENTION

Disclosed herein is a tape that provides a cutting performance enhancer (e.g., lubricant) at the surface the tape is adhered to and where the tool contacts the surface to deform or remove material.

In some embodiments the cutting performance enhancer can be applied to the adhesive side of the tape, for example where the lubricant is a solid or a paste. This results in direct contact of the lubricant with the material being removed or deformed.

Other embodiments may have the cutting performance enhancer sandwiched between two film layers to entrap the lubricant until the layers are punctured. This could be between multiple layers to provide other benefits that are needed for compatibility of layers or for additional benefits.

Yet another embodiment may comprise the cutting performance enhancer within the adhesive layer itself. This could be by means of physically encapsulated lubricants, emulsion, impregnation, or the lubricant itself functioning as the adhesive.

In another embodiment the cutting performance enhancer could be incorporated as, or in, the adhesive carrier (film) such as a paper or foam.

The cutting performance enhancer may come in a variety of forms or combinations thereof. Some may be liquid, waxy, oily, or solid. Some examples are 2-(2-Aminoethoxy) ethanol; 2,4-Pentanediol; 2-methyl-, Triethanolamine; Distillates (petroleum); White mineral oil; Alcohols, C12-15, ethoxylated propoxylated; Aliphatic compounds; Tetradecane, chloro derivs; Pentene, 2,4,4-trimethyl-, sulfurized; Hydrotreated Paraffinic Distillate; Light Hydrotreated Petroleum Distillate; Sulfurized Vegetable Fatty Oil; Tall Oil Fatty Acids; Lard Oil; 3,5 Di-Tert-butyl-4-hydroxy, hydrocinnamic acid, C7-C9 branched esters; Fatty oils and triglycerides; 2-AMINO-2-METHYLPROPANOL; Alcohols, C12-13, ethoxylated; Methyl-1H-benzotriazole; Diethanolamine; 1-tetradecanol; etc., but not limited to these compounds.

The cutting performance enhancer components may aid in lubricity, cooling, chip clearing, and other common benefits provided by cutting lubricants and coolants. This can reduce needed applied force, provide quicker cutting speeds, extended tool life, better surface finish on work piece, and better chip behavior, as well as prevent galling, reduce tool temperature, reduce material temperature, reduce noise but not limited to these traits.

These and other features, aspects and advantages of the present invention will become better understood with reference to the following drawings, description and claims.

### BRIEF DESCRIPTION OF THE DRAWINGS

FIG. 1 is a schematic cross-sectional view of a combination of tape and cutting lubricant/coolant in accordance with an embodiment of the present invention;

FIG. 2 is a schematic cross-sectional view of a combination of tape and cutting lubricant/coolant in accordance with another embodiment of the present invention;

FIG. 3 is a schematic cross-sectional view of a combination of tape and cutting lubricant/coolant in accordance with yet another embodiment of the present invention;

FIG. 4 is a schematic cross-sectional view of a combination of tape and cutting lubricant/coolant in accordance with an embodiment of the present invention;

FIG. 5 is a schematic cross-sectional view of a combination of tape and cutting lubricant/coolant in accordance with an embodiment of the present invention;

FIG. 6 is a schematic cross-sectional view of a combination of tape and cutting lubricant/coolant in accordance with an embodiment of the present invention;

FIG. 7 is a schematic cross-sectional view of a combination of tape and cutting lubricant/coolant in accordance with a still another embodiment of the present invention;

FIG. 8 is a schematic cross-sectional view of a combination of tape and cutting lubricant/coolant in accordance with an additional embodiment of the present invention;

FIG. 9 is a schematic cross-sectional view of a combination of tape and cutting lubricant/coolant in accordance with an additional embodiment of the present invention;

FIG. 10 is a schematic cross-sectional view of a combination of tape and cutting lubricant/coolant in accordance with an additional embodiment of the present invention;

FIG. 11 is a schematic adhesive side view of a combination of tape and cutting lubricant/coolant in accordance with an additional embodiment of the present invention;

FIG. 12 is a schematic adhesive side view of a combination of tape and cutting lubricant/coolant in accordance with an additional embodiment of the present invention;

FIG. 13 is a schematic adhesive side view of a combination of tape and cutting lubricant/coolant in accordance with yet an additional embodiment of the present invention;

FIG. 14 is a schematic adhesive side view of a combination of tape and cutting lubricant/coolant in accordance with still another embodiment of the present invention;

FIG. 15 is a schematic adhesive side view of a combination of tape and cutting lubricant/coolant in accordance with an additional embodiment of the present invention;

FIG. 16 is a schematic marking/top side view of a combination of tape and cutting lubricant/coolant in accordance with an additional embodiment of the present invention;

FIG. 17 is a schematic marking/top side view of a combination of tape and cutting lubricant/coolant in accordance with an additional embodiment of the present invention;

FIG. 18 is a schematic marking/top side view of a combination of tape and cutting lubricant/coolant in accordance with an additional embodiment of the present invention;

FIG. 19 is a schematic cross-sectional view of a combination of tape and cutting enhancement material in accordance with an additional embodiment of the present invention;

FIG. 20 is a schematic cross-sectional view of a combination of tape and cutting lubricant/coolant in accordance with an additional embodiment of the present invention; and

FIG. 21 is a schematic cross-sectional view of a combination of tape and cutting lubricant/coolant in accordance with an additional embodiment of the present invention.

It should be noted that the structures shown in the figures are not intended to be exact representations of shapes, sizes and relative sizes, but are examples of shapes, sizes and relative sizes. For example, when one structure is shown as being the same thickness as another structure, that is not intended to be limiting, but to be an example.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

U.S. Provisional Application No. 63/678,230, filed Aug. 1, 2024, is incorporated in this application by reference.

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims and any claims supported by the disclosure.

Various inventive features are described below that can each be used independently of one another or in combination with other features.

Broadly, embodiments of the present invention provide tape in combination with a cutting lubricant and/or coolant. “Tape” is defined herein as a flexible film with an adhesive on at least one major surface thereof sufficient to maintain the film on the surface at least until cutting or deforming begins, and preferably well into the cutting or deforming process. “Flexible” is defined herein as so lacking the ability to resist deformation (e.g., bending or twisting) that the film conforms, at least to a significant degree, to the surface shape to which it is attached. “Lubricant” is defined herein as a material that substantially reduces the friction between two parts moving relative to one another when in contact. A substantial reduction of friction occurs when the tool wear decreases by at least about 7% over not using the lubricant. In a preferred embodiment, the amount of tool wear from using the present invention decreases by at least about 15%. In a more preferred embodiment, the amount of tool wear from using the present invention decreases by at least about 30%. In an even more preferred embodiment, the amount of tool wear from using the present invention decreases by at least about 60%. In a most preferred embodiment, the amount of tool wear from using the present invention decreases by at least about 200%. “Coolant” is defined herein as a material that substantially facilitates the removal of thermal energy from the workpiece being deformed, or from which material is being removed.

Referring now to FIG. 1, there is a cross-sectional view of a tape comprising a cutting performance enhancer, the combination represented by reference numeral 10 above material 18 to be worked. The combination 10 comprises a substrate layer 12 with an adhesive layer 13 applied to the bottom of the substrate 12. On the bottom of the adhesive layer 13 there is an applied cutting performance enhancer 14. The cutting performance enhancer might comprise a cutting fluid, paste, wax, coolant, lubricant or some combination thereof. In this embodiment the cutting performance enhancer 14 does not cover the entirety of the adhesive layer 13 so as to allow the adhesive layer to still stick to the workpiece 8 material around the cutting performance enhancer 14. The combination 10 may adhere to the workpiece 18 at the adhesive layer 13 with the substrate 12, which may be a film, and the adhesive layer 13 bending to accommodate the thickness of the cutting performance enhancer 14. The substrate layer 12 may be made of paper, plastic or any suitable material.

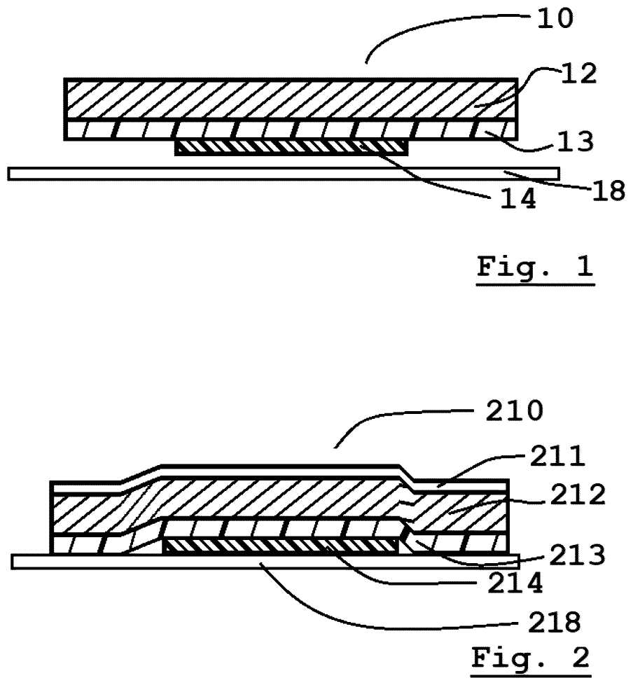

As shown in FIG. 2, there is a cross-sectional view of a tape comprising a cutting performance enhancer, the combination represented by reference numeral 210. The combination 210 demonstrates the ability of the tape (the combination of the substrate 212, adhesive 213 and cutting performance enhancer 214) to conform to a surface affixed to a workpiece 218. The combination may comprise an additional layer 211 on top of the substrate layer 212, which may be a film. This additional layer 211 may comprise a release agent to prevent the adhesion layer 213 from one portion of the combination 210 from adhering to another portion of the combination 210, and thus to prevent self adhesion. This is particularly helpful if the tape is rolled for storage.

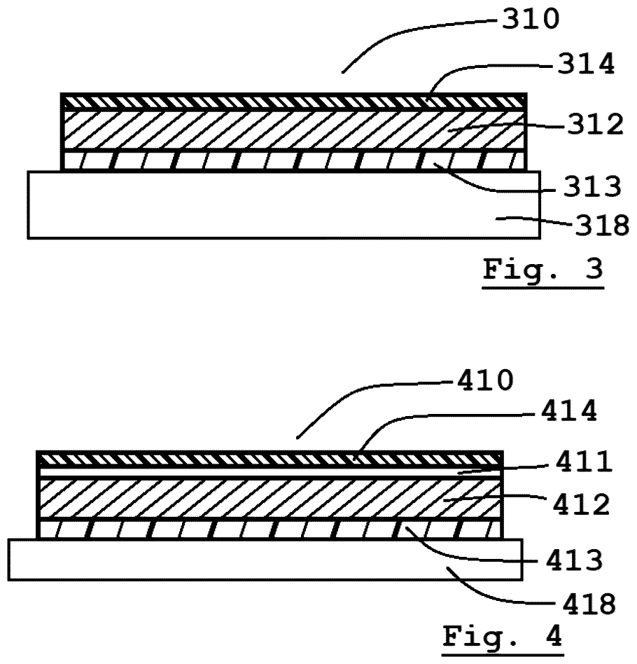

As shown in FIG. 3, there is a cross-sectional view of a tape comprising a cutting performance enhancer, the combination represented by reference numeral 310, affixed to a workpiece 318. The combination may comprise an adhesion layer 313 that is under (in the orientation of FIG. 3) the substrate 312, which may be a film, and the cutting performance enhancer 314 is on top of the substrate 312. FIG. 4 shows the same but with an intermediate layer 411 that may be a release agent between the cutting performance enhancer 414 and the substrate 412.

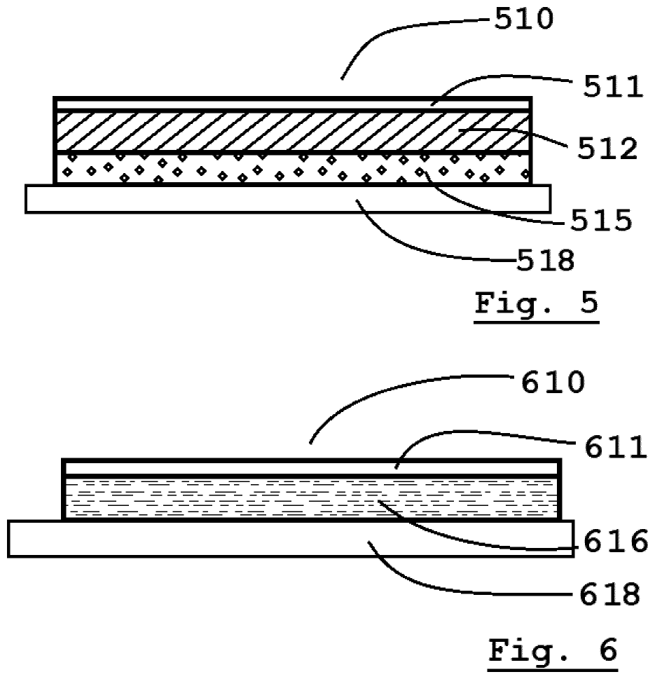

As shown in FIG. 5 there may be a bottom layer 515 that is a combination of adhesive and cutting performance enhancer affixed to a workpiece 518. In one example the cutting performance enhancer is naturally adhesive. In another the cutting performance enhancer is encapsulated with a third material (not shown) and distributed as a matrix in an adhesive. And in another embodiment, the cutting performance enhancer is capable of being impregnated or distributed within adhesive.

As shown in FIG. 6, there may be a layer 616 that comprises a matrix that is capable adhering to the workpiece 618 while part of the matrix comprises cutting performance enhancement properties affixed to a workpiece 618. The matrix may also comprise a backing component(s) that permits the material to be written upon (e.g., to receive layout markings, such as by hand with a conventional writing instrument, visible to the human eye), provide strength, binding, bulking agent, removal of the layer after use, etc. A release layer 611 that permits the invention to be rolled upon itself, or may be a backing component that can be peeled off and removed from the matrix 616 to be left by itself on the workpiece 618.

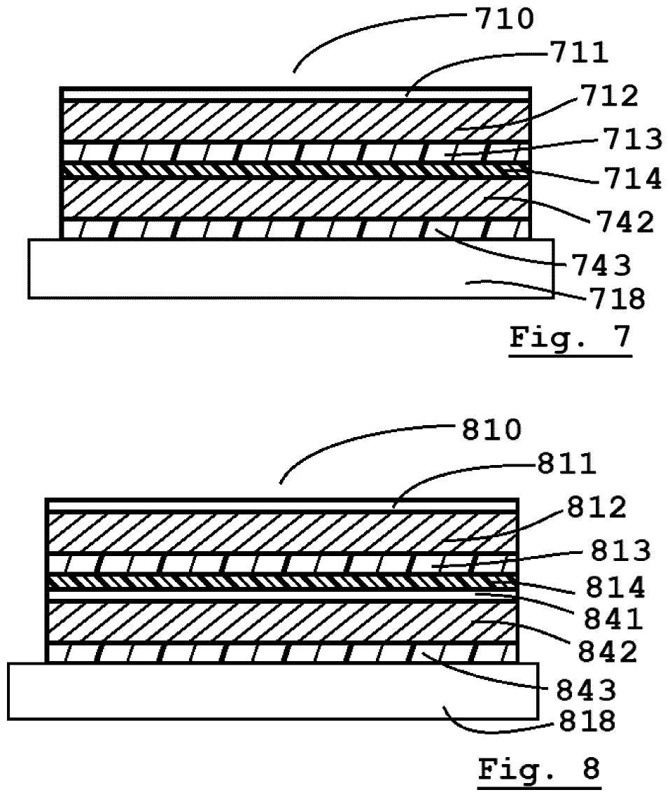

As shown in FIG. 7, the cutting performance enhancement layer 714 may be interposed between a first backing layer 712 paired with a first adhesive layer 713 and a second backing layer 742 paired with a second adhesive layer 743, both of which might be different from the first layers 712 and 713, with the bottom adhesive layer 743 affixed to a workpiece 718. Additionally, it is shown in FIG. 8, that there may be an intermediate layer 841 below the cutting performance enhancement layer 814 that might aid in the retention or attachment of the cutting performance enhancer 814. Additionally, layer 841 might retain the cutting performance enhancement layer 814 sufficiently to the top layers 811, 812 and 813 while leaving sufficient cutting performance enhancement material 814 to be of use.

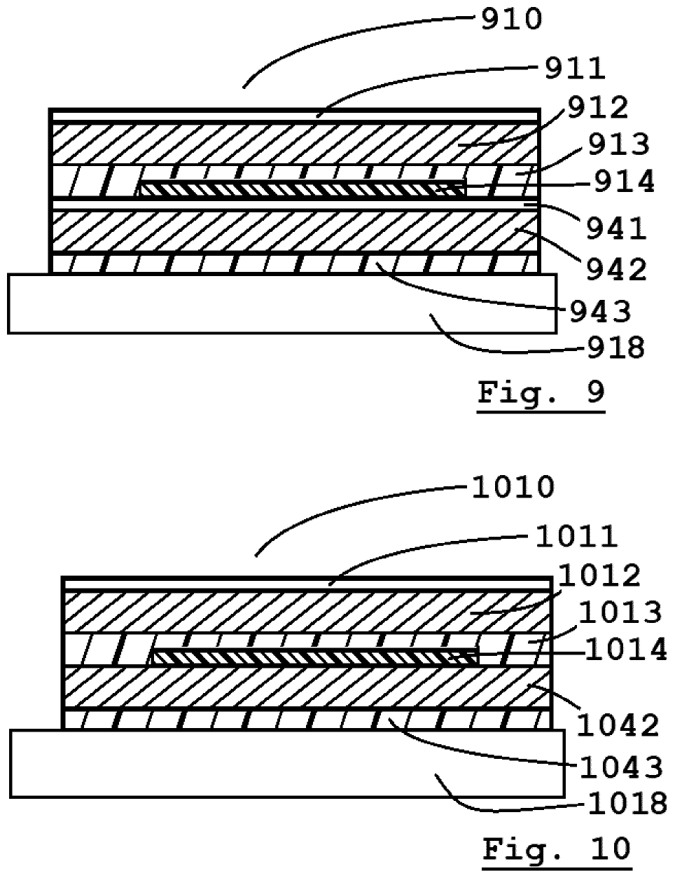

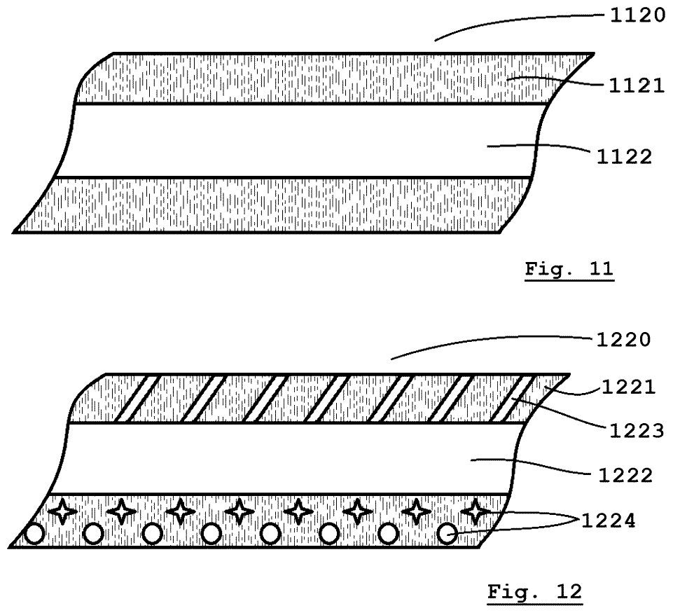

FIG. 9 shows the cutting performance enhancement layer 914 might be encapsulated by a layer 913 that might be, but not limited to, an adhesive, with an additional layer 941 that maybe the same material as 913 or of a different composition. Additionally, 941 might be a release agent that preferentially releases the layer 913, but retains the cutting performance enhancer 914 sufficiently that layers 911, 912, and 913 can be peeled off to expose the cutting performance enhancer 914. FIG. 10 shows the cutting performance enhancement layer 1014 might be encapsulated by an adhesive layer 1013.

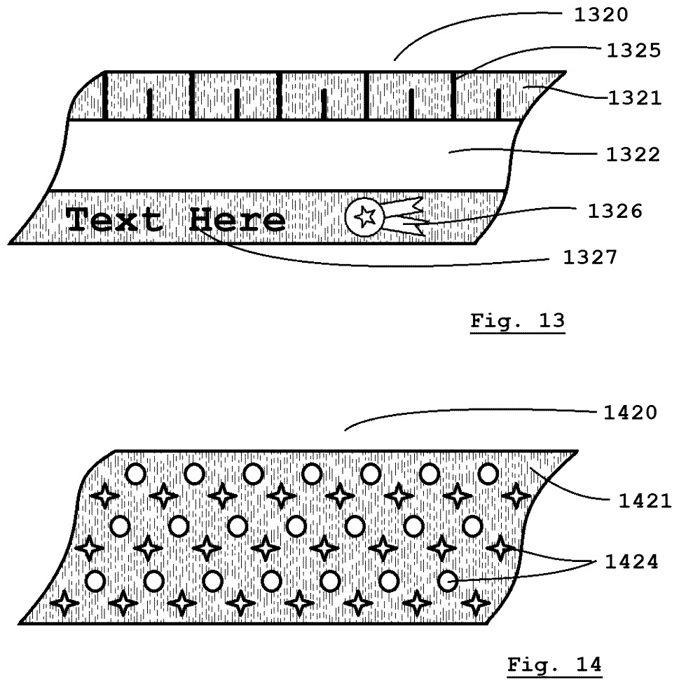

FIG. 11 show a bottom view of a tape 1120 with a cutting performance enhancer. In one example the cutting performance enhancer 1122 doesn't cover the entirety of the adhesive layer 1121 so as to permit the tape to be applied to a work surface (not shown). Attached to a work surface, the tape 1120 would have an appearance from the side that is similar to the tape shown in FIG. 2.

Additionally, FIG. 12 shows that the cutting performance enhancer 1222 might be applied in such a way as to provide stripes 1223, patterns 1224 or other indicia. Furthermore, FIG. 13 shows that the cutting performance enhancer 1322 might be used to display markings to measure length as in “ruler” indicia 1325, text as in characters 1327, or images 1326. Additionally, it is possible to envision that the distance markings 1325, text 1327, and image 1326 might not comprise entirely or only partially cutting performance enhancement material, but rather may be comprised of entirely or partially an ink to be viewed through the entire product 1320 for use on the opposite side.

Additionally, FIG. 14 shows that the application of the cutting performance enhancer 1424 might not consist of a contiguous application.

However, as shown in FIG. 15, it is possible to extend the cutting performance enhancer 1522 to at least one edge.

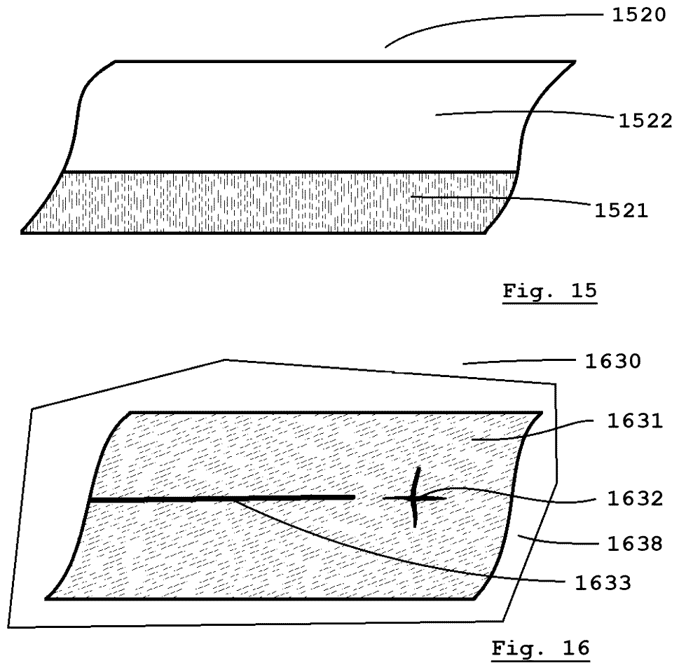

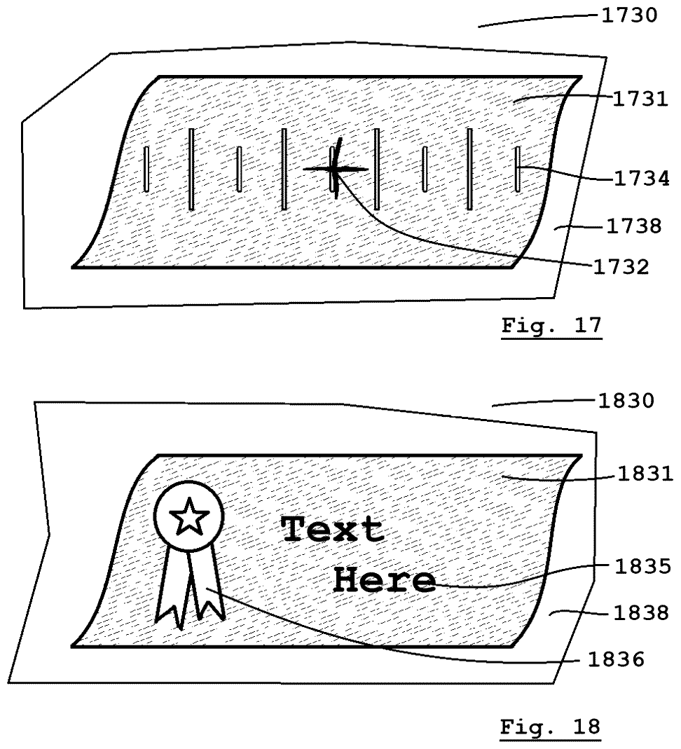

As shown in FIG. 16, a top view of a tape 1630 with a cutting performance enhancer and the tape 1630 permits visible markings 1632 & 1633, which may be added by human user or machine to the top layer 1631 of the current invention. These markings 1632 & 1633 can provide locations for material removal or shearing operations by a user. Additionally shown is the workpiece 1638.

Additionally, FIG. 17 shows that the current invention allows for markings 1734 to be printed to indicate distances that might comprise of a cutting performance enhancer, ink, or some combination thereof. A user or machine might apply a mark 1732 to indicate the location for an operation to modify (such as drilling, deforming, denting, etc.) the workpiece 1738. Furthermore, FIG. 18 shows that text 1835 and images 1836 may be applied to the top 1831 of the disclosed invention that might comprise of a cutting performance enhancer, ink, or some combination thereof.

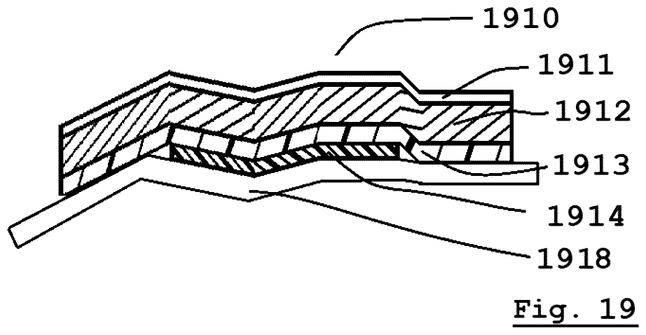

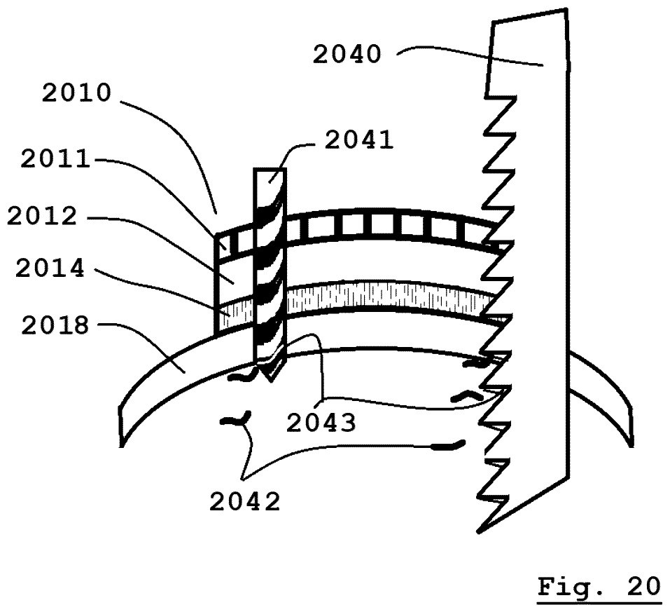

FIG. 19 shows the conforming nature of the current invention applied to a non flat workpiece 1918 demonstrating how the cutting performance enhancer 1914 can be attached to the non-flat workpiece 1918 by the adhesive 1913.

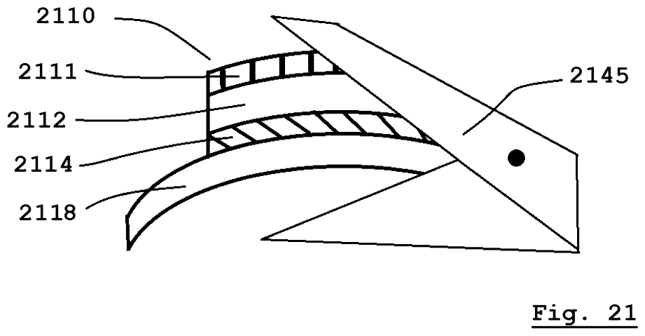

FIG. 20 shows a cross sectional view along the invention applied to a curved workpiece 2018 with a saw blade 2040 and a drill bit 2041 penetrating the invention and having the cutting performance enhancer 2014 picked up by the tools and carried along 2043 interacting with the tooling and producing chips 2042 of the removed material.

FIG. 21 shows shears 2145 cutting through the combination 2110 and a workpiece 2118 without creating chips.

It should be understood that the foregoing relate to exemplary embodiments of the invention and that modifications may be made without departing from the spirit and scope of the invention as set forth in the following claims. This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A tape comprising:
(a) a film with at least first and second major, oppositely-facing surfaces:
(b) an adhesive layer disposed on at least the first surface, wherein the adhesive layer covers at least a portion of the first surface; and
(c) a cutting performance enhancement layer formed on at least one of the surfaces of the film.

2. The tape in accordance with claim 1, wherein the cutting performance enhancement layer is a cutting coolant.

3. The tape in accordance with claim 1, wherein the cutting performance enhancement layer is a cutting lubricant.

4. The tape in accordance with claim 1, wherein the cutting performance enhancement layer is disposed on the first surface within the adhesive layer.

5. The tape in accordance with claim 1, wherein the cutting performance enhancement layer is disposed on the first surface adjacent the adhesive layer.

6. The tape in accordance with claim 1, wherein the cutting performance enhancement layer is disposed on at least a portion of the second surface.

7. The tape in accordance with claim 1, further comprising a plurality of layers disposed on the second surface, wherein the cutting performance enhancement layer is disposed on at least one of the plurality of layers.

8. The tape in accordance with claim 1, further comprising at least a third layer disposed on at least a portion of the second surface.

9. The tape in accordance with claim 8, wherein the cutting performance enhancement layer is disposed on at least a portion of the second surface between the film and the third layer.

10. The tape in accordance with claim 8, wherein the cutting performance enhancement layer is disposed on the third layer.

11. The tape in accordance with claim 8, wherein the cutting performance enhancement layer is disposed within the third layer.

12. The tape in accordance with claim 1, wherein the second surface includes indicia visible to the human eye.

13. The tape in accordance with claim 1, wherein the second surface can receive layout markings visible to the human eye.

14. The tape in accordance with claim 1, wherein the cutting performance enhancement decreases tool weary by at least about 7%.

15. A tape comprising:
(a) a film with at least first and second major, oppositely-facing surfaces:
(b) an adhesive layer disposed on at least the first surface, wherein the adhesive layer covers at least a portion of the first surface; and
(c) a cutting performance enhancement material disposed within the film.

16. The tape in accordance with claim 15, wherein the cutting performance enhancement layer is a cutting coolant.

17. The tape in accordance with claim 15, wherein the cutting performance enhancement layer is a cutting lubricant.

18. The tape in accordance with claim 15, wherein the second surface includes indicia visible to the human eye.

19. The tape in accordance with claim 15, wherein the second surface can receive layout markings visible to the human eye.

20. A combination tape, tool and workpiece, the combination comprising:
(a) a film with at least first and second major, oppositely-facing surfaces:
(b) an adhesive layer disposed on at least the first film surface, wherein the adhesive layer covers at least a portion of the first film surface and adheres to a workpiece surface;
(c) a cutting performance enhancement layer formed on at least one of the film surfaces; and
(d) the tool disposed in contact with both the tape and the workpiece for cutting the workpiece, wherein the cutting performance enhancement layer is configured for enhancing the cutting of the workpiece by the tool.
